(19) United States
(12) Patent Application Publication
(10) Pub. No.: US 2008/0018601 A1
(43) Pub. Date: Jan. 24, 2008

(54) Cursor-controlling mechanism

(76) Inventor: Chih-Wen Su, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/714,794

(22) Filed: Mar. 7, 2007

(30) Foreign Application Priority Data
Jul. 21, 2006 (TW) 95212892

(51) Int. Cl. G06F 3/033

(52) U.S. Cl. 345/166; 345/167

(57) ABSTRACT

The cursor-controlling mechanism includes a beam splitter, a light source, an image sensor and a mouse ball. The light source is positioned beside one side of the beam splitter, and the image sensor is positioned above the beam splitter. The mouse ball is rotatably positioned beside the other side of the beam splitter. The light source emits light beam at the beam splitter, and the light beam is divided into two sub-beams by the beam splitter. One sub-beam maintains original optical path toward the mouse ball and hits the mouse ball. The other sub-beam is directed downwardly to hit a worktable. The image sensor detects surface beneath the cursor-controlling mechanism and obtains image. By position of the mouse ball and surface beneath the cursor-controlling mechanism, the cursor-controlling mechanism has the functionality of mouse and trackball.

### BACKGROUND OF THE INVENTION

1. Field of the Invention

The present invention relates to a cursor-controlling mechanism, and in particular to a cursor-controlling mechanism having functionalities of mouse and trackball.

2. Description of Related Art

Mouse is one of the important input devices of computers. Mice are classified into two types: mechanical mouse and optical mouse. As to mechanical mouse, a ball is rotatably positioned at the bottom of the mouse. The ball drives sense device enclosed within the mouse because the mouse is dragged so that distance of mouse moved is calculated.

Optical mouse has replaced the mechanical mouse because the manufacturing process is stable and cost is reasonable. It doesn't need to clean the optical mouse frequently, and the optical mouse has good capability against weariness. Besides, with the advent of time, accuracy of mechanical parts of the mechanical mouse is getting lower and lower. Regarding the optical mouse, it uses a light source (such as laser or light-emitting diode (LED)) to project on the worktable so that several areas with different intensities are generated. Distance and direction of the optical mouse moved are calculated by image sensor and digital signal processor. Taiwan Patent No. 590286 issued on Jun. 1, 2004 discloses a mechanical improvement for optical mouse.

However, optical mouse does not necessarily have trackball. If the trackball needs to be integrated with the optical mouse, then it needs two sets of light sources and image sensors. Thus, number of parts and cost will be increased. Besides, the sets of light sources and image sensors consume much more space so that volume of optical mouse is large. The optical mouse will not be compact, slim and light-weighted. Thus, there is a need for a cursor-controlling mechanism.

### SUMMARY OF THE INVENTION

It is an object of the present invention to provide a cursor-controlling mechanism that has functionalities of mouse and trackball and one set of light source and an image sensor. Cost and number of parts of the cursor-controlling mechanism are lowered, and the cursor-controlling mechanism consumes much less space and is slim, compact and light-weighted.

To achieve the object of the present invention, the cursor-controlling mechanism includes a beam splitter, a light source, an image sensor and a mouse ball. The light source is positioned beside one side of the beam splitter, and the image sensor is positioned above the beam splitter. The mouse ball is rotatably positioned beside the other side of the beam splitter.

The light source emits light beam at the beam splitter, and the light beam is divided into two sub-beams by the beam splitter. One sub-beam maintains original optical path toward the mouse ball and hits the mouse ball. The other sub-beam is directed downwardly to hit a worktable. The image sensor detects surface beneath the cursor-controlling mechanism and obtains image. By position of the mouse ball and surface beneath the cursor-controlling mechanism, the cursor-controlling mechanism has the functionality of mouse and trackball.

### BRIEF DESCRIPTION OF THE DRAWINGS

The present invention can be fully understood from the following detailed description and preferred embodiment with reference to the accompanying drawings, in which:

FIG. 1 is a cross-sectional view of a cursor-controlling mechanism according to the first embodiment of the present invention;

FIG. 2 is a cross-sectional view of a cursor-controlling mechanism according to the second embodiment of the present invention;

FIG. 3 is a cross-sectional view of a cursor-controlling mechanism according to the third embodiment of the present invention;

FIG. 4 is a cross-sectional view of a cursor-controlling mechanism according to the fourth embodiment of the present invention; and

FIG. 5 is a cross-sectional view of a cursor-controlling mechanism according to the fifth embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

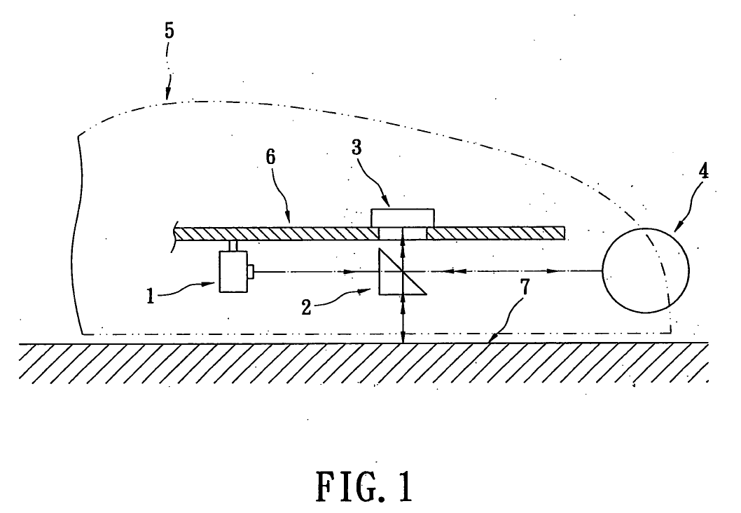

Referring to FIG. 1, the present invention provides a cursor-controlling mechanism including a light source 1, a beam splitter 2, an image sensor 3 and a mouse ball 4. The light source 1 is a laser beam source or a light emitting diode (LED). According to the first embodiment, the light source 1 is a laser beam source. The light source 1 is positioned within a housing 5 and electrically connected with a printed circuit board 6. The printed circuit board 6 is also positioned within the housing 5.

The beam splitter 2 is positioned within the housing 5, and the light source 1 is positioned beside one side of the beam splitter 2. The light source 1 emits light beam at the beam splitter 2, and the light beam is divided into two sub-beams by the beam splitter 2. One sub-beam maintains original optical path, and the other sub-beam is directed downwardly and perpendicular to the original optical path.

The image sensor 3 is positioned within the housing 5 and above the beam splitter 2. The image sensor 3 is electrically connected with the printed circuit board 6, and the direction and distance of mouse and mouse ball 4 moved are calculated via digital signal processor after the image sensor 3 detects surface beneath the cursor-controlling mechanism and obtains image.

There is no restriction to material that the mouse ball 4 is made of. The mouse ball 4 is rotatably pivoted to the housing 5 and exposes out of the one side of the housing 5. Thus, it is convenient for user to touch and rotate the mouse ball 4 by his fingers. The mouse ball 4 is positioned beside the other side of the beam splitter 2; that is, the beam splitter 2 is positioned between the light source 1 and the mouse ball 4.

According to the present invention, the cursor-controlling mechanism uses the light source 1 to generate a light beam. The light beam is directed at the beam splitter 2 and divided into two sub-beams. One sub-beam maintains the original optical path toward the mouse ball 4 and is reflected to the beam splitter 2 then is refracted upwardly to the image sensor 3 by the beam splitter 2. When the mouse ball 4 is rotated by user, light beams hit at the mouse ball 4 so that images with different intensities are formed. The images are constantly obtained by the image sensor 3 and processed by the digital signal processor so that direction and distance of the mouse ball 4 moved are calculated to fulfill capability of trackball.

The other sub-beam from the beam splitter 2 is refracted downwardly at the worktable 7 and reflected upwardly to the beam splitter 2. The other sub-beam is sensed by the image sensor 3. When the cursor-controlling mechanism of the present invention is dragged, the images with different intensities are formed on the worktable 7. The images are constantly obtained by the image sensor 3 and processed by the digital signal processor so that direction and distance of the mouse ball 4 moved are calculated to fulfill capability of mouse.

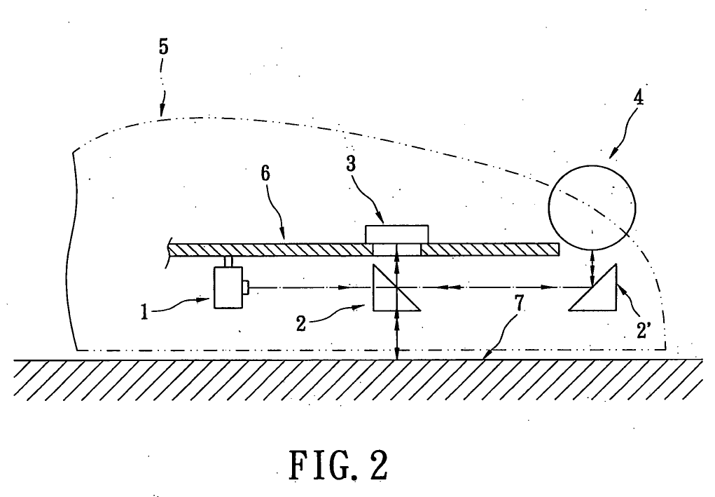

Referring to FIG. 2, the second embodiment of the present invention is shown. The present invention provides a cursor-controlling mechanism with a beam splitter 2′. The beam splitter 2′ is positioned at the other side of the beam splitter 2, and the mouse ball 4 is positioned above the beam splitter 2′. Thus, compared with the first embodiment, position of the mouse ball 4 is higher and the mouse ball 4 exposes out of a top side of the housing 5. It is convenient for user to rotate the mouse ball 4.

According to the second embodiment, one sub-beam from the beam splitter 2 maintains the original optical path and is directed at the mouse ball 4 by the beam splitter 2′. The sub-beam is further reflected to the beam splitter 2′ by the mouse ball 4. Finally, the sub-beam is reflected and directed toward the image sensor 3 by the beam splitter 2 and 2′.

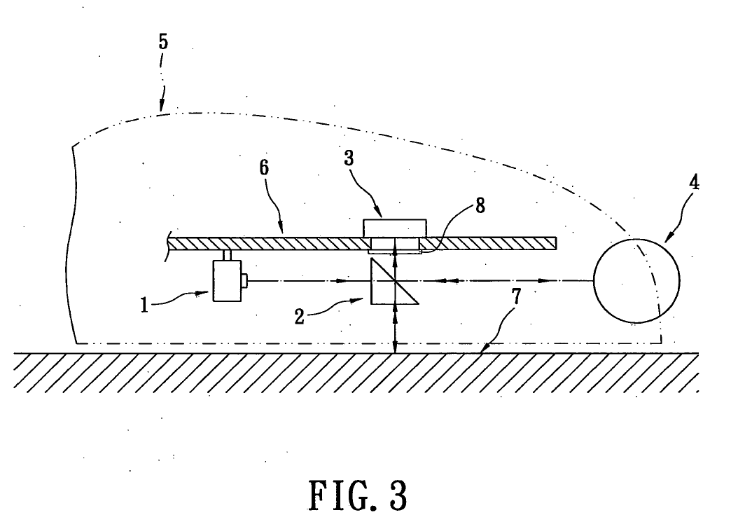

Referring to FIG. 3, the light source 1 is a light emitting diode (LED) so a lens needs to be positioned between the beam splitter 2 and the image sensor 3 to focus light beams of the light source 1.

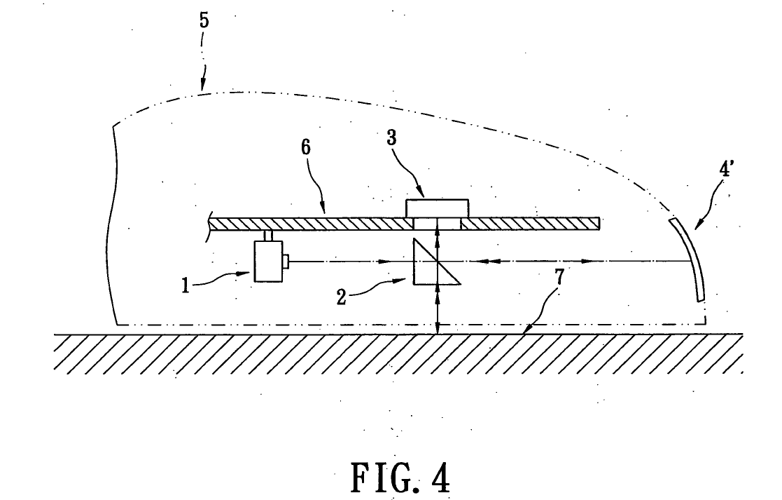

Referring to FIG. 4, the fourth embodiment uses a transparent component 4′ to replace the mouse ball 4 described above. The transparent component 4′ is made of but not limited to glass. The transparent component 4′ is fixed at the housing 5 so that user's finger moves on the transparent component 4′. The images are constantly obtained by the image sensor 3 and processed by the digital signal processor so that direction and distance of the user's finger moved are calculated to fulfill capability of mouse.

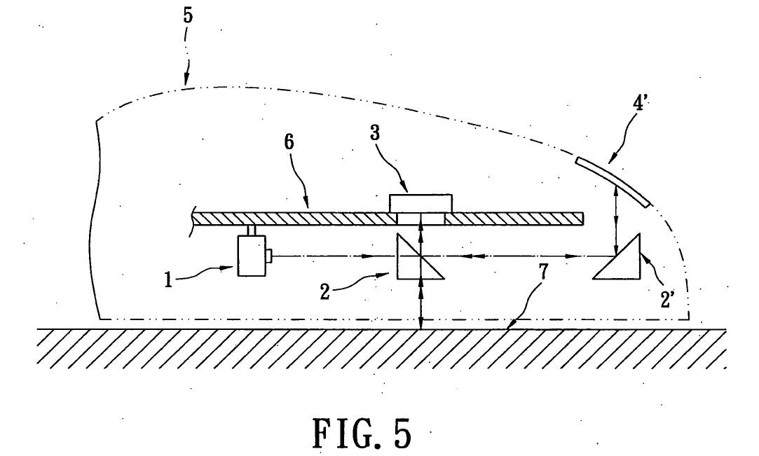

Referring to FIG. 5, difference between the fifth embodiment and the fourth embodiments is the beams splitter 2′. The beam splitter 2′ is positioned beside the other side of the beam splitter 2, and the transparent component 4′ is positioned above the beam splitter 2′. Thus, compared with the fourth embodiment, position of the transparent component 4′ is higher and the transparent component 4′ is fixed at top of the housing 5.

The present invention has a capability of mouse and trackball and one set of light source and an image sensor. Cost and number of parts of the cursor-controlling mechanism of the present invention are lowered, and the cursor-controlling mechanism consumes much less space and is slim, compact and light-weighted.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A cursor-controlling mechanism, comprising:
a beam splitter;
a light source, positioned beside one side of the beam splitter;
an image sensor, positioned above the beam splitter; and
a mouse ball, rotatably positioned beside the other side of the beam splitter.

2. The cursor-controlling mechanism as claimed in claim 1, wherein the light source is a laser beam source.

3. The cursor-controlling mechanism as claimed in claim 1, wherein the light source is a light emitting diode (LED), and a lens is positioned between the beam splitter and the image sensor.

4. The cursor-controlling mechanism as claimed in claim 1, wherein the light source and the image sensor are electrically connected with a printed circuit board.

5. The cursor-controlling mechanism as claimed in claim 1, wherein the light source, the beam splitter and the image sensor are positioned within a housing, and the mouse ball is rotatably pivoted on the housing.

6. The cursor-controlling mechanism as claimed in claim 5, wherein the mouse ball is exposed out of a top side or one side of the housing.

7. The cursor-controlling mechanism as claimed in claim 1, further comprising a second beam splitter positioned beside the other side of the beam splitter, and the mouse ball positioned above the second beam splitter.

8. A cursor-controlling mechanism, comprising:
a beam splitter;
a light source, positioned beside one side of the beam splitter;
an image sensor, positioned above the beam splitter; and
a transparent component, positioned beside the other side of the beam splitter.

9. The cursor-controlling mechanism as claimed in claim 8, wherein the light source is a laser beam source.

10. The cursor-controlling mechanism as claimed in claim 8, wherein the light source is a light emitting diode (LED), and a lens is positioned between the beam splitter and the image sensor.

11. The cursor-controlling mechanism as claimed in claim 8, wherein the light source and the image sensor are electrically connected with a printed circuit board.

12. The cursor-controlling mechanism as claimed in claim 8, wherein the light source, the beam splitter and the image sensor are positioned within a housing and the mouse ball is rotatably pivoted on the housing.

13. The cursor-controlling mechanism as claimed in claim 12, wherein the transparent component is exposed out of a top side or one side of the housing.

14. The cursor-controlling mechanism as claimed in claim 8, further comprising a second beam splitter positioned beside the other side of the beam splitter, and the mouse ball positioned above the second beam splitter.
